(19) United States
(12) Patent Application Publication
(10) Pub. No.: US 2004/0052710 A1
(43) Pub. Date: Mar. 18, 2004

(54) Method of operating a flue gas purifying plant and apparatus for carrying out the method

(76) Inventor: Gisbert Wolfgang Kafer, Birmenstof (CH)

Correspondence Address: ADAM J. CERMAK, P.O. BOX 7518, ALEXANDRIA, VA, 22307-7518, US

(21) Appl. No.: 10/660,522

(22) Filed: Sep. 12, 2003

(30) Foreign Application Priority Data
Sep. 14, 2002 (DE) 102 42 775.5

(51) Int. Cl. B01D 53/60

(52) U.S. Cl. 423/239.1; 422/171

(57) ABSTRACT

In a method of operating a flue gas purifying plant (10) having at least one absorber chamber (11) in which CO and NO are oxidized simultaneously by means of a catalyst in a first absorber (15) according to the SCONOx principle and the resulting NO₂ is absorbed on the catalyst surface, and in which, furthermore, SO₂ is oxidized by means of a catalyst in a second absorber (14) connected upstream of the first absorber (15) according to the SCOSOx principle and the resulting SO₃ is absorbed on the catalyst surface, the absorber chamber (11) is separated from the flue gas flow in regularly recurring regeneration cycles and is regenerated by means of a regeneration gas containing hydrogen, the two absorbers (14, 15) of the absorber chamber (11) being regenerated one after the other.

In such a method, the risk of deactivation of the SCONOx absorber (15) by residual SO₃ from the SCOSOx absorber (14) is reduced by virtue of the fact that regeneration gas flows through the two absorbers (14, 15) against the direction of the flue gas flow during the regeneration.

### BACKGROUND OF THE INVENTION

1. Field of the Invention

The present invention relates to the field of flue gas purifying technology. It relates to a method of operating a flue gas purifying plant according to the preamble of claim 1 and to an apparatus for carrying out the method.

2. Discussion of Background

A relatively new process for reducing NOx emissions in combustion flue gases of gas turbines, diesel engines and the like is known by the trade name SCONOx. NOx is deposited as potassium nitrite and potassium nitrate on a SCONOx absorber (in this respect see U.S. Pat. No. 5,953,911 and the article by L. Czarnecki et al., SCONOX—Ammonia Free NOx Removal Technology For Gas Turbines, Proc. of 2000 Int. Joint Power Generation Conf., Miami Beach, Fla., Jul. 23-26, 2000).

Since the SCONOx absorber can easily be deactivated by SO₂ in the flue gas, another absorber, a “SCOSOx absorber” is connected upstream of it, said SCOSOx absorber absorbing SO₂ from the flue gas and thus protecting the SCONOx absorber. The chemical reactions occurring in the two absorbers are described in detail in the abovementioned article by L. Czarnecki.

As soon as the depositing capacity of at least one of the absorbers is exhausted (typically after about 20 minutes), the absorbers have to be regenerated. This is achieved by all the absorbers in their entirety being subdivided into individual chambers which can be separated individually from the flue gas flow by changeover dampers. For the regeneration, in each case selected chambers are separated from the flue gas flow, while the other chambers remain in the flue gas flow. A regeneration gas which consists of hydrogen, hydrocarbon, e.g. natural gas, and an oxygen-rich carrier gas (normally steam) is then fed through the separated chambers in order to regenerate both the NOx absorber and the SO₂ absorber of the respective chamber. However, since the two different absorber types behave differently during the regeneration, they are separately regenerated. This is made possible by the arrangement of feed and discharge lines and valves for the regeneration, as reproduced by way of example in FIG. 1.

FIG. 1 shows an absorber chamber 11 of a flue gas purifying plant 10, through which flue gas from a combustion process is fed for purifying. The unpurified flue gas 25 flows into the chamber 11 from the left. The purified flue gas 26 discharges again from the chamber 11 to the right. For regeneration purposes, the chamber 11 can be separated from the flue gas flow by two dampers 12 and 13, which are arranged at the inlet and outlet. In the figure, the dampers 12, 13 are just closed.

In the chamber 11, a first absorber 14 (SCOSOx) for the absorption of SO₂ and a second absorber 15 (SCONOx) for the absorption of NOx are arranged one behind the other at a distance apart in the direction of flow. A feed line 27 for the regeneration gas and having a first valve 17 (inlet valve) opens into the intermediate space between the first and second absorbers 14 and 15, respectively. Connected upstream of the first absorber 14 and downstream of the second absorber 15 in the direction of flow are in each case discharge lines 21 and 24, respectively, into which a second and a third valve 16 and 19 (outlet valve), respectively, are inserted. The first valve (inlet valve) 17 is opened during the regeneration phase, so that regeneration gas can flow in. The other two valves (outlet valves) 16 and 19 are opened one after the other, so that the associated absorbers 14 and 15, respectively, are regenerated one after the other. The SO₂ absorber 14 is normally regenerated first (valve 16 open; valve 19 closed). The regeneration gas in the feed line 27 is produced by means of a reformer 20 from steam 23 and methane-containing natural gas added via a valve 18.

In the flue gas purifying plant 10, there are typically about ten chambers 11 of the type shown in FIG. 1 connected in parallel, of which two are in the regeneration phase at each instant. With a regeneration time of 5 minutes per individual regeneration, a total of 25 minutes are required in order to regenerate the chambers 11 once (=25 minutes cycle time).

It is a known characteristic of the SCOSOx catalyst that its regeneration takes place fairly slowly. The SCOSOx regeneration can therefore never be completed with an acceptable expenditure of time, but rather must be interrupted at a point in time. Some gaseous SO₂ therefore always remains in the SCOSOx section when the regeneration has been completed. There is the risk of this SO₂ either diffusing to the SCONOx absorber if the SCOSOx absorber has been generated first, or of being flushed through the flowing flue gas to the SCONOx absorber if the SCONOx absorber has been regenerated first. The SO₂, which enters the SCONOx catalyst by means of one of these mechanisms, may then contribute decisively to the deactivation of the SCONOx catalyst.

### SUMMARY OF THE INVENTION

Accordingly, one object of the invention is to provide a novel method of operating a SCOSOx/SCONOx flue gas purifying plant, which method reliably avoids the deactivation of the SCONOx catalyst by residual SO₂ from the SCOSOx absorber, and to provide a novel arrangement for carrying out the method.

The object of the invention is achieved by all the features of claims 1 and 4 in their entirety. The essence of the invention consists in allowing the regeneration gas to flow through the absorber chamber and the different absorbers during the regeneration phase in such a way that residual SO₂ present in the SCOSOx absorber is flushed out of the absorber without being able to act in a deactivating manner in the SCONOx absorber. This is done by regeneration gas flowing through the two absorbers against the direction of the flue gas flow during the regeneration.

In particular, the regeneration gas, in the direction of the flue gas flow, is in each case fed downstream of the absorbers and is discharged upstream of the second absorber.

During the regeneration phase, preferably the second absorber is regenerated first and then the first absorber is regenerated.

A preferred configuration of the apparatus according to the invention is characterized by the fact that a reformer is provided for producing the regeneration gas, to which reformer natural gas and steam are fed, and in that the feed lines are connected to the outlet of the reformer.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 shows the exemplary construction of an individual chamber with SCONOx and SCOSOx absorbers and regeneration devices from a flue gas purifying plant, as used in the prior art; and

FIG. 2 shows, in a representation comparable with FIG. 1, a flue gas purifying plant modified in the sense of the invention.

### DESCRIPTION OF THE PREFERRED EMBODIMENTS

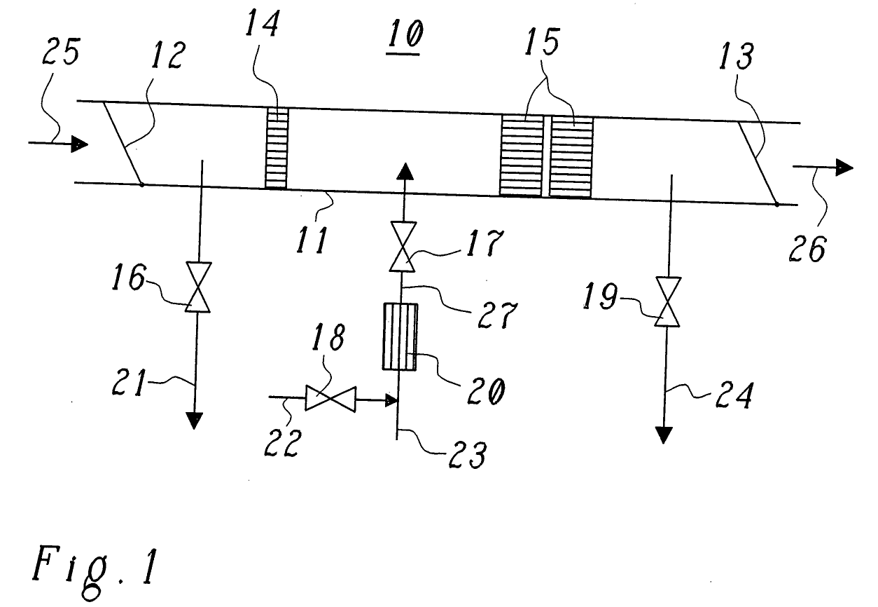

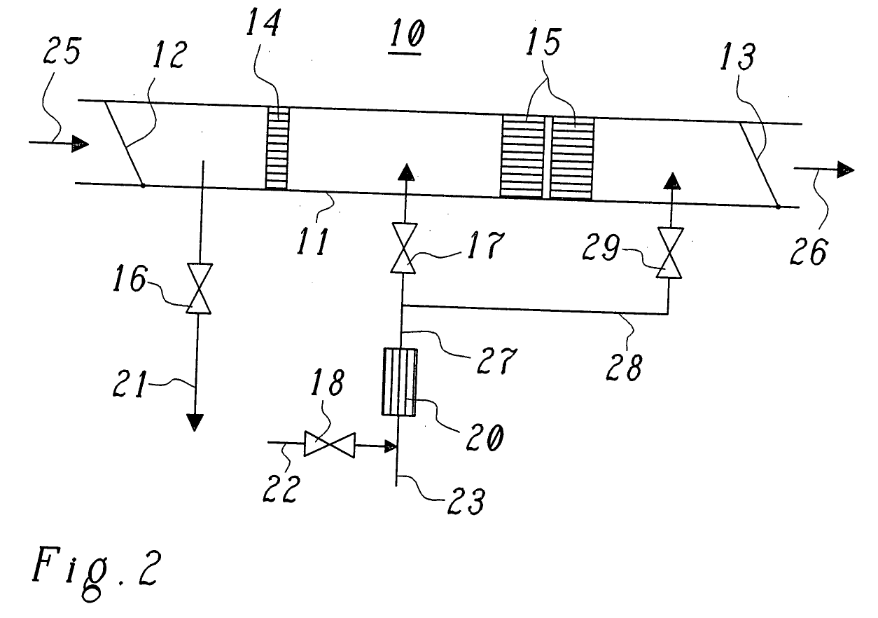

Referring now to the drawings, wherein like reference numerals designate identical or corresponding parts throughout the several views, a valve arrangement having two inlet valves and only one outlet valve is proposed according to the invention for the regeneration in order to prevent the SO₂ from entering the SCONOx catalyst during the regeneration phase. A preferred exemplary embodiment for a suitable arrangement of inlet and outlet valves in a flue gas purifying plant is reproduced in FIG. 2. The change compared with the configuration shown in FIG. 1 consists in the fact that the outlet valve 19 having the discharge line 24 connected thereto has been replaced by an inlet valve 29 which is connected via a feed line 28 to the feed line 27 between the other inlet valve 17 and the reformer.

In the arrangement shown in FIG. 2, the regeneration gas always flows from the SCONOx absorber 15 to the SCOSOx absorber 14. In this way, the situation in which SO₂ diffuses from the absorber 14 to the absorber 15 can be avoided. The regeneration gas contains hydrogen and/or hydrogenous compounds, e.g. hydrocarbons, such as natural gas or propane. Since higher hydrocarbons can be converted more easily into methane (main constituent of natural gas), this can constitute an alternative to natural gas if locally available. The use of higher hydrocarbons directly for the regeneration, i.e. without prior conversion into hydrogen, is conceivable.

The SCOSOx absorber 14 is preferably regenerated first. For this purpose, the inlet valve 17 and the outlet valve 16 are opened; the inlet valve 29 remains closed. Once the regeneration of the SCOSOx absorber 14 has been completed, the SCONOx absorber 15 is regenerated by the inlet valve 17 being closed, with outlet valve 16 opened, and by the inlet valve 29 being opened instead. The regeneration gas used for the regeneration of the SCONOx absorber 15 then flushes the SO₂ remaining in the SCOSOx section from the absorber chamber 11 through the discharge line 21. This avoids a situation in which residual SO₂ remaining in the section is flushed by the flue gas into the SCONOx absorber 15 when the dampers 12, 13 are opened again after completion of the regeneration phase.

The advantage of the method according to the invention depends to a considerable extent on the actual flow conditions in the absorber chamber 11 and on the

LIST OF DESIGNATIONS

| | |
|---|---|
| 10 | Flue gas purifying plant |
| 11 | Absorber chamber |
| 12, 13 | Damper |
| 14 | Absorber (SCOSOx) |
| 15 | Absorber (SCONOx) |
| 16-19 | Valve |
| 20 | Reformer |
| 21, 24 | Discharge line (regeneration) |
| 22 | Natural gas (NG) |
| 23 | Steam |
| 25 | Flue gas (unpurified) |
| 26 | Flue gas (purified) |
| 27, 28 | Feed line (regeneration) |
| 29 | Valve |

What is claimed as new and desired to be secured by Letters Patent of the United States is:

1. A method of operating a flue gas purifying plant (10) having at least one absorber chamber (11) in which CO and NO are oxidized simultaneously by means of a catalyst in a first absorber (15) according to the SCONOx principle and the resulting NO₂ is absorbed on the catalyst surface, in which, furthermore, SO₂ is oxidized by means of a catalyst in a second absorber (14) connected upstream of the first absorber (15) according to the SCOSOx principle and the resulting SO₃ is absorbed on the catalyst surface, in which method the absorber chamber (11) is separated from the flue gas flow in regularly recurring regeneration cycles and is regenerated by means of a regeneration gas containing hydrogen and/or hydrogenous compounds, the two absorbers (14, 15) of the absorber chamber (11) being regenerated one after the other, characterized in that regeneration gas flows through the two absorbers (14, 15) against the direction of the flue gas flow during the regeneration.

2. The method as claimed in claim 1, characterized in that the regeneration gas, in the direction of the flue gas flow, is in each case fed downstream of the absorbers (14, 15) and is discharged upstream of the second absorber (14).

3. The method as claimed in either of claims 1 or 2, characterized in that, during the regeneration phase, the second absorber (14) is regenerated first and then the first absorber (15) is regenerated.

4. An apparatus for carrying out the method as claimed in claim 1, comprising at least one absorber chamber (11) which lies in the flue gas flow and can be separated from the flue gas flow from time to time, preferably by dampers (12, 13), and in which the two absorbers (14, 15) are arranged one behind the other in the direction of the flue gas flow, characterized in that, in the direction of the flue gas flow, a feed line (27, 28) provided with an inlet valve (17, 19) and intended for the regeneration gas opens into the absorber chamber (11) in each case downstream of each of the two absorbers (14, 15) in the direction of the flue gas flow, and in that a discharge line (21) provided with an outlet valve (16) and intended for the used regeneration gas branches off from the absorber chamber (11) upstream of the second absorber (14) in the direction of the flue gas flow.

5. The apparatus as claimed in claim 4, characterized in that a reformer (20) is provided for producing the regeneration gas, to which reformer (20) natural gas (22) or other hydrocarbons and steam (23) are fed, and in that the feed lines (27, 28) are connected to the outlet of the reformer (20).
